(19) United States
(12) Patent Application Publication
(10) Pub. No.: US 2026/0313073 A1
(43) Pub. Date: Oct. 8, 2026

(54) REUSABLE VIRTUAL CONFERENCE SPACE

(71) Applicant: Avaya Management L.P., Morristown, NJ (US)

(72) Inventor: Terry Fee-Lung Tam, Ottawa (CA)

(21) Appl. No.: 19/098,980

(22) Filed: Apr. 2, 2025

(51) Int. Cl. H04N 7/15

(52) U.S. Cl. CPC H04N 7/157

(57) ABSTRACT

Systems and methods are provided for a single virtual office space assigned to a particular individual for multiple uses in a safe and secure manner to address the proliferation of meeting issues. The virtual office space may be used concurrently. Work is done and after the meeting is complete, the participants leave, and the organizer puts the new data into the file and stores the file back into the filing cabinet.

### FIELD OF THE DISCLOSURE

The invention relates generally to systems and methods for online collaboration and conferencing and particularly to personal collaboration.

### BACKGROUND

Conferencing tools have provided remote participants with the ability to join meetings without being physically present. Conferencing tools have advanced from voice-only telephony systems to include other media, such as video and file sharing. Additionally, conferencing tools have advanced to include additional services, such as recording, translation, and transcription.

The evolution of conferencing has included the advent of audio phone conferencing through a bridge on a private branch exchange (PBX), scheduled ad-hoc video conferencing via an add-on video conferencing server, and a major shift with the concept of meetings and virtual meeting spaces.

The jump to meetings was dramatic, changing the way people worked and collaborated. Individuals can host meetings in a wide variety of spaces, providing virtually limitless possibilities. Each meeting typically has a random unique identifier to encapsulate all the meeting sessions and stored data associated with a particular meeting topic.

Despite these advances, challenges and opportunities to advance the state of the art remain.

### SUMMARY

Prior art collaboration tools are focused on group collaboration, such as a group of individuals intercommunicating or a single individual communicating to a group (e.g., in a lecture, presentation, etc.). Day-to-day personal collaboration needs are outside the scope of these prior art collaboration tools.

An individual may create many meetings, each utilizing a virtual meeting space. This freedom and openness of the meetings include noticeable drawbacks, which can be explained by modelling each meeting space as a physical office space. To illustrate certain differences, consider a physical office space. An individual may be responsible for managing hundreds or even thousands of office spaces individually. Practically, a team would be needed to keep track of and manage all the properties and, eventually, the individual would become a full-time administrator and would not be able to do their original job. If the individual cannot manage these physical properties, they may lose track of which properties they own, forget to pay taxes, have squatters maliciously use the properties, and other issues.

This physical world analogy is akin to the prior art of meeting applications. The proliferation of meetings that occurs today leads to issues related to security, compliance, performance, usability, and resources. It gets exponentially more difficult to manage and track the meetings as an individual creates more of them over time. Every time a person creates a new event in their calendar and selects the option that it is an online meeting, a new meeting is created.

In the old PBX conferencing days, the calendar invite typically would be "call my assigned phone number and I'll form a bridge from the PBX." In many ways, the traditional PBX conference model resembles a model of a single office space per employee, and the modern meeting model is an unbounded number of office spaces per employee. What is missing is a bridge to the gap between PBX driven conferencing and independent meeting services with the merging of legacy usability experience and modern meeting usability experience, which will address the security, compliance, resource/performance, and usability issues with meetings today.

These and other needs are addressed by the various embodiments and configurations of the present invention. The present invention can provide a number of advantages depending on the particular configuration. These and other advantages will be apparent from the disclosure of the invention(s) contained herein.

Embodiments are disclosed that provide a single virtual office space assigned to a particular individual for multiple uses in a safe and secure manner to address the proliferation of meeting issues. The virtual office space may be used concurrently. A physical representation of the embodiments may be viewed starting with an enclosed office for an organizer. As a new meeting occurs, participants enter the office at the assigned time, and the organizer pulls files out of their filing cabinet for the context of the meeting. Work is done, and after the meeting is complete, the participants leave, and the organizer puts the new data into the file and stores the file back into the filing cabinet. This is known herein as a "personal meeting."

In one embodiment, a calendared meeting is decomposed into a meeting address, runtime collaboration resources (such as a video conference service, chat service, data sharing resource (screen share, whiteboard, etc.), recording service, file sharing service, etc.), and tenanted persistent storage, which holds the data after a meeting session has finished.

In another embodiment, the meeting's address is used to access the personal meeting and is assigned to a user. The meeting address is the same as the user's identity, such as an identity within an organization (e.g., an employee number, a telephone number/extension, an email address, etc.). In one embodiment, the meeting address is assigned to the user's Direct Inward Dial (DID) number and/or the user's login identifier (ID). The DID number may be recommended to allow for audio-only phone devices to also join the meeting.

In another embodiment, runtime collaboration resources and the persistent data are separated from the traditional concept of a meeting identifier (ID). The meeting ID is the container abstraction for a storage location (e.g., a memory location, storage media address, etc.), which holds all content of a meeting at runtime and offline persistence. The separation allows for the persistent data to be tenanted properly under a single meeting address. As a benefit, tenanting the meeting's persistent data allows for easy migration between competing meeting services. For example, the prior art may utilize one video conferencing tool and move to a different tool within the same tenanted storage. In contrast, migrating to a different video conferencing tool in the prior art requires the tool to be discontinued (and often removed) and a replace tool reinstalled and configured.

In another embodiment, a unique meeting name and unique meeting correlation identifier (e.g., "ID"), which tenant the persistent data and active session for a particular meeting session, are provided. The unique meeting correlation ID may be a hidden parameter which cannot be viewed by a user. The meeting name is the human-readable form of the identifier. From a physical analogy, the meeting correlation ID/meeting name is indexed as a file, while the persistent storage is a filing cabinet.

In another embodiment, scheduling capability is provided, which determines when the meeting address is active, and which unique meeting correlation ID/meeting name and related data are used for the scheduled session. The meeting name can be scheduled as many times as the owner wishes if it does not overlap with another session using the same meeting address.

In another embodiment, the permission and policies for the meeting address and the data associated with the meeting correlation ID/meeting address are provided and may be inherited from the user identity to allow for central policy management (such as a directory service).

In some aspects, the techniques described herein relate to a method, including: presenting, by a server, a first virtual meeting space for use by a number of participants and conducting a first communication between the number of participants utilizing a corresponding number of participant devices; allocating, by the server, a first number of collaboration resources to the first virtual meeting space; receiving, by the server, from a first participant device of the number of participant devices, a first meeting identifier associated with the first virtual meeting space and, in response, admitting a first participant of the number of participants utilizing the first participant device to the first virtual meeting space; creating, by the server, first meeting data utilizing at least one collaboration resource of the first number of collaboration resources; persistently maintaining the first meeting data in a first tenanted virtual meeting space; and upon the first participant device exiting the first virtual meeting space and subsequently being readmitted to the first virtual meeting space, resuming creation, by the server, of the first meeting data utilizing the at least one collaboration resource of the first number of collaboration resources.

In some aspects, the techniques described herein relate to a method, further including: presenting, by the server, a second virtual meeting space for use by the number of participants and conducting a second communication between the number of participants utilizing the corresponding number of participant devices; allocating, by the server, a second number of collaboration resources to the second virtual meeting space; receiving, by the server, from a second participant device of the number of participant devices, a second meeting identifier associated with the second virtual meeting space and, in response, admitting a second participant of the number of participants utilizing the second participant device to the second virtual meeting space; creating, by the server, second meeting data utilizing the at least one collaboration resource of the second number of collaboration resources; persistently maintaining the second meeting data in a second tenanted virtual meeting space; and upon the second participant device exiting the second virtual meeting space and subsequently being readmitted to the second virtual meeting space, resuming creation, by the server, of the second meeting data utilizing the at least one collaboration resource of the second number of collaboration resources.

In some aspects, the techniques described herein relate to a method, further including: administering, by an administrative server, data retention policies to each of the first tenanted virtual meeting space and the second tenanted virtual meeting space.

In some aspects, the techniques described herein relate to a method, further including: administering, by an administrative server, security policies to each of the first tenanted virtual meeting space and the second tenanted virtual meeting space determining whether to admit any participant, including at least one of the first participant and the second participant, to a particular virtual meeting space, including at least one of the first virtual meeting space and the second virtual meeting space.

In some aspects, the techniques described herein relate to a method, wherein the first number of collaboration resources and the second number of collaboration resources are an identical set of collaboration resources.

In some aspects, the techniques described herein relate to a method, wherein the first number of collaboration resources and the second number of collaboration resources each include at least one resource including audio, video, messaging, text chat, email, screen sharing, whiteboarding, conferencing, file sharing, file transfer, presence information, floor control, and recording.

In some aspects, the techniques described herein relate to a method, wherein the first meeting identifier is one of a direct inward dial (DID) or a user identifier.

In some aspects, the techniques described herein relate to a method, further including: receiving, by the server, from the first participant device, the first meeting identifier associated with the first virtual meeting space and, in response, declining to admit the first participant upon one of (a) a failure to match the first participant or the first participant device to an authorized list of participants or (b) the time the first meeting identifier was received by the server is outside a designated meeting time.

In some aspects, the techniques described herein relate to a system, including: a network; a computer, the computer including at least one processor coupled to a computer memory having stored thereon instructions that cause the at least one processor to perform: presenting a first virtual meeting space for use by a number of participants and conducting a first communication between the number of participants utilizing a number of participant devices corresponding to the number of participants; allocating a first number of collaboration resources to the first virtual meeting space; receiving, from a first participant device of the number of participant devices, a first meeting identifier associated with the first virtual meeting space and, in response, admitting a first participant of the number of participants utilizing the first participant device to the first virtual meeting space; creating first meeting data utilizing at least one collaboration resource of the first number of collaboration resources; persistently maintaining the first meeting data in a first tenanted virtual meeting space; and upon the first participant device exiting the first virtual meeting space and, at a later time, being readmitted to the first virtual meeting space, resuming creation of the first meeting data utilizing the at least one collaboration resource of the first number of collaboration resources.

In some aspects, the techniques described herein relate to a system, wherein the instructions further cause the processor to perform: presenting a second virtual meeting space for use by a number of participants and conducting a second communication between the number of participants utilizing a corresponding number of participant devices; allocating a second number of collaboration resources to the second virtual meeting space; receiving, from a second participant device of the number of participant devices, a second meeting identifier associated with the second virtual meeting space and, in response, admitting a second participant of the number of participants utilizing the second participant device to the second virtual meeting space; creating second meeting data utilizing at least one collaboration resource of the second number of collaboration resources; persistently maintaining the second meeting data in a second tenanted virtual meeting space; and upon the second participant device exiting the second virtual meeting space and, at a later time, being readmitted to the second virtual meeting space, resuming creation of the second meeting data utilizing the at least one collaboration resource of the second number of collaboration resources.

In some aspects, the techniques described herein relate to a system, wherein the instructions further cause the processor to perform: administering, by an administrative server, data retention policies to each of the first tenanted virtual meeting space and the second tenanted virtual meeting space.

In some aspects, the techniques described herein relate to a system, wherein the instructions further cause the processor to perform: administering, by an administrative server, security policies to each of the first tenanted virtual meeting space and the second tenanted virtual meeting space determining whether to admit any participant, including at least one of the first participant and the second participant, to a particular virtual meeting space, including at least one of the first virtual meeting space and the second virtual meeting space.

In some aspects, the techniques described herein relate to a system, wherein the first number of collaboration resources and the second number of collaboration resources are an identical set of collaboration resources.

In some aspects, the techniques described herein relate to a system, wherein the first number of collaboration resources and the second number of collaboration resources each include at least one resource including audio, video, messaging, text chat, email, screen sharing, whiteboarding, conferencing, file sharing, file transfer, presence information, floor control, and recording.

In some aspects, the techniques described herein relate to a system, wherein the first meeting identifier is one of a direct inward dial (DID) or a user identifier.

In some aspects, the techniques described herein relate to a system, wherein the first meeting identifier is an email address.

In some aspects, the techniques described herein relate to a system, wherein the instructions further cause the processor to perform: receiving, from the first participant device, the first meeting identifier associated with the first virtual meeting space and, in response, declining to admit the first participant upon one of (a) a failure to match the first participant or the first participant device to an authorized list of participants or (b) the time the first meeting identifier was received is outside a designated meeting time.

In some aspects, the techniques described herein relate to a computer-readable medium coupled to a processor, the medium including one or more computer readable instructions, the processor executing the one of more computer readable instructions to: present a first virtual meeting space for use by a number of participants and conduct communication between the number of participants utilizing a corresponding number of participant devices; allocate a first number of collaboration resources to the first virtual meeting space; receive, from a first participant device of the number of participant devices, a first meeting identifier associated with the first virtual meeting space and, in response, admit a first participant of the number of participants utilizing the first participant device to the first virtual meeting space; create first meeting data utilizing at least one collaboration resource of the first number of collaboration resources; persistently maintain the first meeting data in a first tenanted virtual meeting space; and upon the first participant device exiting the first virtual meeting space and, at a later time, being readmitted to the first virtual meeting space, resume creation of the first meeting data utilizing the at least one collaboration resource of the first number of collaboration resources.

In some aspects, the techniques described herein relate to a computer-readable medium, wherein the one or more computer readable instructions to cause the processor to execute: presenting a second virtual meeting space for use by a number of participants and conducting communication between the number of participants utilizing a corresponding number of participant devices; allocating a second number of collaboration resources to the second virtual meeting space; receiving, from a second participant device of the number of participant devices, a second meeting identifier associated with the second virtual meeting space and, in response, admitting a second participant of the number of participants utilizing the second participant device to the second virtual meeting space; creating second meeting data utilizing at least one collaboration resource of the second number of collaboration resources; persistently maintaining the second meeting data in a second tenanted virtual meeting space; and upon the second participant device exiting the second virtual meeting space and, at a later time, being readmitted to the second virtual meeting space, resuming creation of the second meeting data utilizing the at least one collaboration resource of the second number of collaboration resources.

In some aspects, the techniques described herein relate to a computer-readable medium, wherein the one or more computer readable instructions cause the processor to execute: administering, by an administrative server, data retention policies to each of the first tenanted virtual meeting space and the second tenanted virtual meeting space including security policies to each of the first tenanted virtual meeting space and the second tenanted virtual meeting space determining whether to admit any participant, including at least one of the first participant and the second participant, to a particular virtual meeting space, including at least one of the first virtual meeting space and the second virtual meeting space.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The term "meet" as used herein refers to the physical and/or procedural (i.e., software controlled and/or configured hardware) aspects of a communication between two or more people. "Meet," "meeting," "collaboration," "conference," and similar terminology, as used herein, refer to communications between two or more people enabled by the use of two or more networked communication devices to convey the entirety or a portion of a communication (e.g., file exchange, audio, whiteboard, etc.). At least two networked communication devices, each utilized by at least one person to participate in the meeting (or similar term), are used to enable the meeting. Meetings that are conducted solely between people physically proximate and/or otherwise communicating naturally (e.g., speaking, seeing, hearing, etc.), and without the benefit of networked communication devices, is excluded and does not apply to "meet," "meeting," "collaboration," "conference," and the like, as used herein. Unless expressly stated otherwise, the use of any one term to describe an exchange between people over a network (e.g., "meeting") may be used interchangeably with any other term of a similar meaning (e.g., "conference").

The phrases "at least one," "one or more," "or," and "and/or" are open-ended expressions that are both conjunctive and disjunctive in operation. For example, each of the expressions "at least one of A, B, and C," "at least one of A, B, or C," "one or more of A, B, and C," "one or more of A, B, or C," "A, B, and/or C," and "A, B, or C" means A alone, B alone, C alone, A and B together, A and C together, B and C together, or A, B, and C together.

The term "a" or "an" entity refers to one or more of that entity. As such, the terms "a" (or "an"), "one or more," and "at least one" can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a tenant space in accordance with embodiments of the present disclosure;

FIG. 3 depicts a live tenant space in accordance with embodiments of the present disclosure;

FIG. 4 depicts a process in accordance with embodiments of the present disclosure; and

FIG. 5 depicts a device of a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

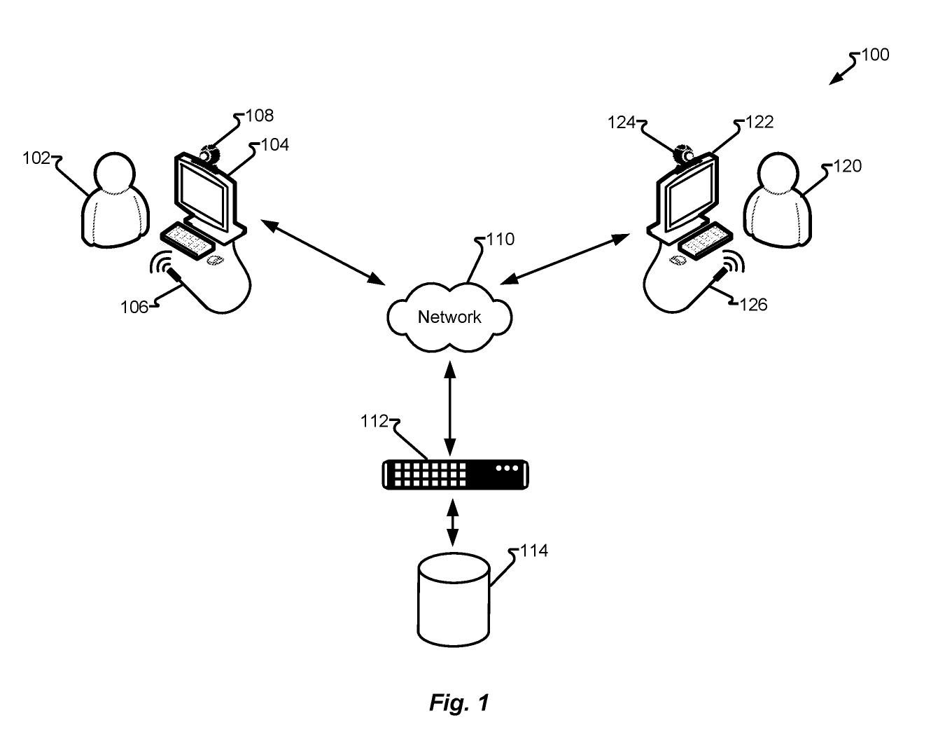

FIG. 1 depicts system 100 in accordance with embodiments of the present disclosure. In one embodiment, user 102 utilizes user device 104 to connect to server 112 via network 110. User device 104 is variously embodied and may include a personal computer (as illustrated), a cellular phone, tablet, laptop, and/or any other device comprising a network interface to a network (e.g., network 110). Similarly, network 110 may comprise a public network (e.g., Internet), private network, telephony, wired and/or wireless networks (e.g., Wi-Fi, cellular, etc.) and/or other networking hardware provided to convey convent between user device 104, server 112, and/or other network components.

In one embodiment, user device 104, operated by user 102, is authenticated to server 112. In response, server 112 allocates (if new) or accesses (if existing) a number of collaboration resources to a first virtual meeting space. The number of collaboration resources includes, but is not limited to, one or more of audio conferencing, video conferencing, text messaging (e.g., simple message system (SMS)), text chat, email, screen sharing, whiteboarding, conferencing, file sharing, file editing, file creation, file transfer, presence information, floor control, and conference recording. The files may be created, shared, edited, etc., in accordance with an application (e.g., a document, spreadsheet, etc.) that may be provided via application programming interface (API) to server 112, and/or to user device 104, and presented to user 102 via user device 104.

When user 102 utilizes the first virtual meeting space, files and/or applications allocated to the particular first virtual meeting space are made available. Data (e.g., files, updated records, etc.) created during the session are maintained in the first virtual meeting space, that is, in a tenanted partition for use during the meeting. Once user 102 logs off (or otherwise departs the first virtual meeting space), the data is maintained in a storage (e.g., an electronic "filing cabinet"), such as database 114 and/or other storage device(s), similarly tenanted for the user. When user 102 logs on again, the persistent storage is again made available to user 102.

While the foregoing describes collaboration with respect a single user (e.g., user 102) using the first virtual meeting space, additional users may utilize the same virtual meeting space. For example, user 120 utilizing user device 122 may log on or otherwise be authenticated to server 112. In one embodiment, user 120 may have unrestricted access to the first virtual meeting space and, as a result, have access to the resources of the first virtual meeting space. In another embodiment, user 120 may be given restricted access to the first virtual meeting space. For example, user 102 may have authorized user 120 to access the first virtual meeting space, such as to utilize a particular resource (e.g., a video conferencing application), at a particular time. If user 120 attempts to access the first virtual meeting space outside of the particular time, they may be refused or put into a reception hold requiring user 102 to authorize entry to the first virtual meeting space. When authorized, user 120 is admitted to the first virtual meeting space and given access to the resources therein, such as to participate in a video conference utilizing the video conferencing application. For example, camera 108 and microphone 106 may be utilized to capture images and speech, respectively, of user 102, encoded for transmission over network 110 and provided to user device 122. Similarly, camera 124 and microphone 126 capture images and speech of user 120 for encoding and transmission over network 110 to user device 104. Additionally or alternatively, server 112 may execute a host portion of the conferencing application and utilize features therein, which may include recording, translation, transcription, whiteboarding, file sharing, etc.

The tenanted first virtual meeting space may be configured for access, data retention, etc., based on policies for all tenanted first virtual meeting spaces maintained by server 112. In another embodiment, the first virtual meeting space may be identified by an identifier ("ID") associated with user 102. For example, user 120 may utilize user device 122 (when embodied as a voice-only telephone) to dial a DID associated with user 102 and be admitted to the first virtual meeting space without further action. Automatic entry to the meeting space may be provided if user 102 is scheduled to participate in a meeting or otherwise is provided rights to enter the first meeting space without further action. Additionally or alternatively, user 120 may be presented with an interactive voice response (IVR) or other means (e.g., dual-tone multi-frequency (DTMF) inputs, etc.) of options to select whether they are requesting entry to the first virtual meeting space or another option.

Tenanting of the virtual meeting spaces refers to the practice of allocating and managing space, power, and networking resources for multiple clients within the same facility or as a common entity. This approach allows all users having virtual meeting spaces to share the infrastructure, such as server 112, database 114, etc., while maintaining strict separation of their operations and data. Generally, but not necessarily, tenanting refers to multi-tenant data centers (MTDCs). MTDCs offer a shared infrastructure where tenants (e.g., user 102, user 120, etc.) utilize virtualized or partitioned resources. This model is popular for cloud services and software-as-a-service (SaaS) providers.

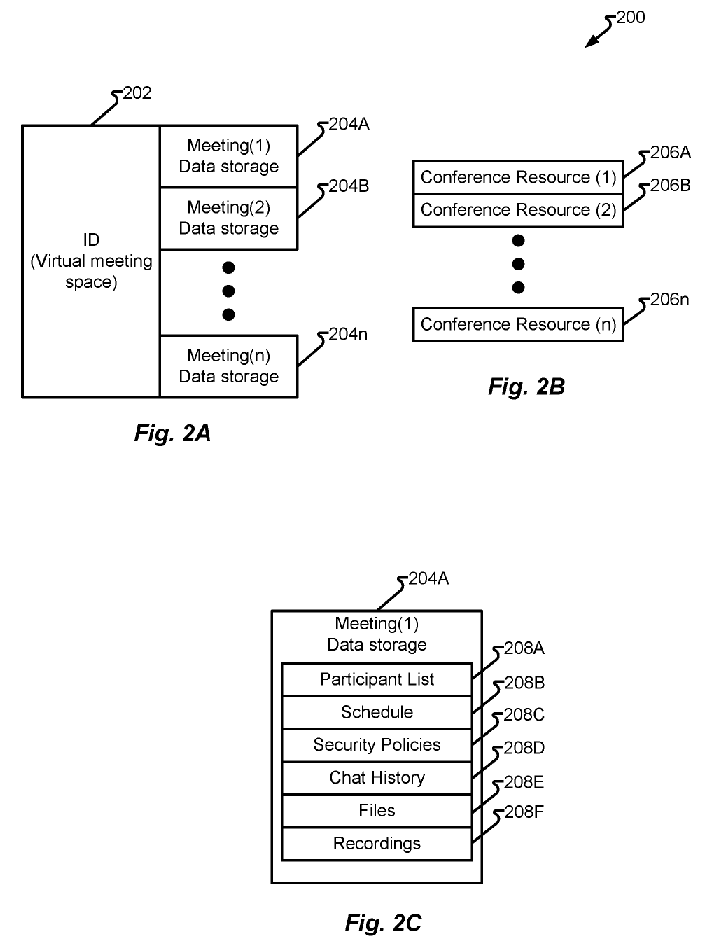

FIG. 2A-2C depict tenant space 200 in accordance with embodiments of the present disclosure. In one embodiment, tenant space 200 is maintained in one or more servers (e.g., server 112) and/or data storage devices (e.g., database 114) and segmented into non-sharable records. As a result, one tenant space 200 is used to provide one virtual meeting space (e.g., the first virtual meeting space) and the data and applications, which may be maintained on common hardware, are accessible to another virtual meeting space (e.g., the second virtual meeting space).

In one embodiment, tenant space 200 may comprise a virtual meeting space which is identified by or further comprise ID 202, such as the email or DID number of an assigned user, and a plurality of meeting data storage 204 (e.g., meeting data storage 204A-204n).

In another embodiment, illustrated by FIG. 2C, Meeting data storage 204A-204n further comprises a repository of meeting features 208. Meeting features 208 may comprise one or more of participant list 208A, schedule 208B, security policies 208C, chat history 208D, files 208E, and/or recordings 208F. Participant list 208A may be used to restrict meeting data storage to only those identified therein. Schedule 208B may be used to restrict access to meetings to only those times identified therein. Security policies 208B may be used to regulate who may access a virtual meeting (e.g., watching or listening only available to anyone within a company, speaking limited to certain participants, access within a corporate firewall only, etc.). Chat history 208D maintains text and/or video chats that have occurred during past iterations of the virtual meeting. Files 208E maintains documents, images, spreadsheets, etc., used in the virtual meeting. Recordings 208F maintains audio and/or video records used or created during the virtual meeting.

In another embodiment, conference resources 206A-206n may be used by the virtual meeting. Examples of conference resources 206A-206n include a particular conferencing application (e.g., Zoom, Teams, etc.), media players, file editors, etc., When used, a conference resource 206 may be allocated, instantiated, and/or configured for use during the virtual meeting.

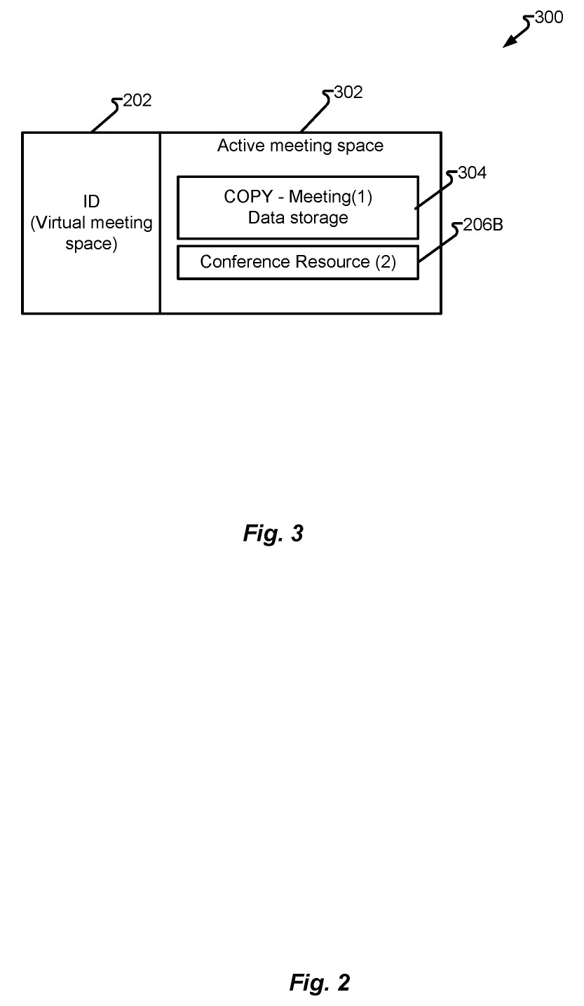

FIG. 3 depicts live tenant space 300 in accordance with embodiments of the present disclosure. In one embodiment, when a virtual meeting space with a particular identifier 202 is active, active meeting space 302 is created. Copy of meeting data storage 304 is made available for use (such as a copy of meeting(1) data storage 204A, which is entirely segregated from the remaining meeting data storage 204B-204n). As a result, a copy of the contents of meeting data storage 204A is made available as active meeting space 302. Additionally, any required conference resources, such a conference resource 206B is made available.

In another embodiment, when the virtual meeting ends, the contents of the copy of active meeting space 304 is wrote to storage to become an instance of a meeting data storage (such as meeting data storage 204A). Any allocated conference resources, such as conference resource 206B is released, terminated, or otherwise concluded.

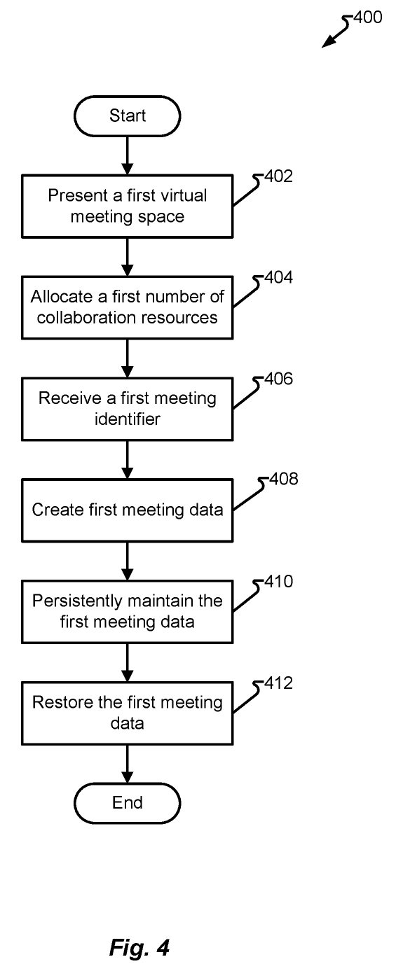

FIG. 4 depicts process 400 in accordance with embodiments of the present disclosure. In one embodiment, process 400 is embodied as machine-readable instructions maintained in a non-transitory memory that when read by a machine, such as processors of a server, cause the machine to execute the instructions and thereby execute process 400. The processor of the server may include, but is not limited to, at least one processor of server 112

In one embodiment, process 400 begins and, in step 404, a first virtual meeting space is presented for use by a number of participants (such as users, e.g., user 102, user 120, etc.). the first virtual meeting space is then made available to conduct a first communication between the number of participants utilizing a corresponding number of participant devices.

Step 404 then allocates a first number of collaboration resources to the first virtual meeting space.

Step 406 receives from a first participant device (such as user device 104, user device 122, etc.) of the number of participant devices, a first meeting identifier associated with the first virtual meeting space and, in response, admits a first participant of the number of participants utilizing the first participant device to the first virtual meeting space.

Step 408 creates first meeting data utilizing at least one collaboration resource of the first number of collaboration resources.

Step 410 persistently maintains the first meeting data in a first tenanted virtual meeting space. For example, the resulting data from the meeting is stored as tenanted data in database 114 or another storage device.

Step 412, upon the first participant device exiting the first virtual meeting space or otherwise ending the meeting, and subsequently being readmitted to the first virtual meeting space, resumes creation, by the server, of the first meeting data utilizing the at least one collaboration resource of the first number of collaboration resources. For example, some or all of meeting data stored in database 114 is loaded to server 112 and, if necessary, services required to execute resources in the tenanted data are made available or launched.

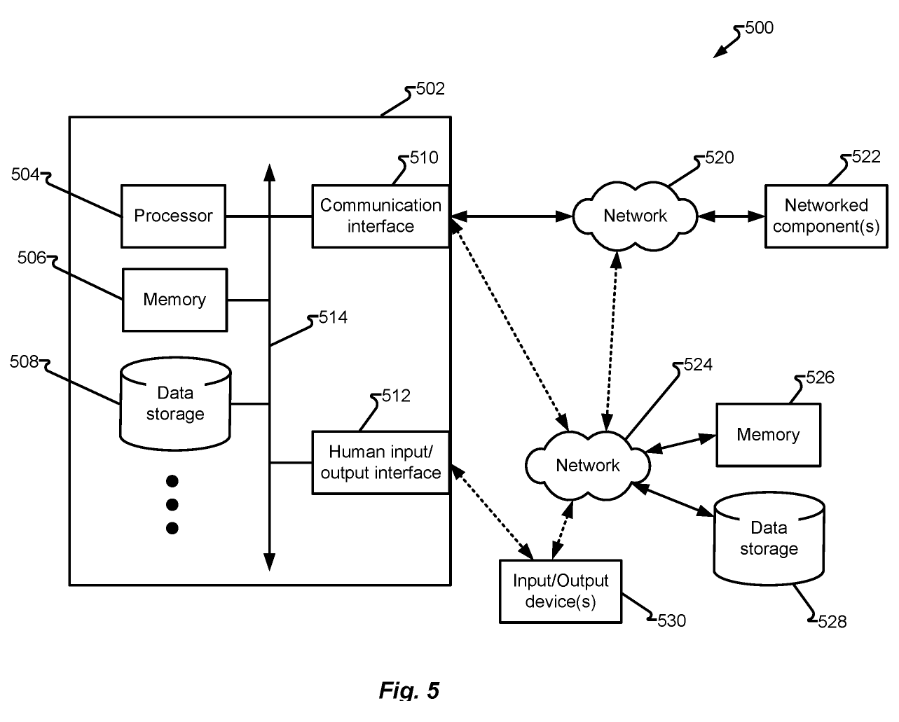

FIG. 5 depicts device 502 in system 500 in accordance with embodiments of the present disclosure. In one embodiment, user device 104, user device 122, and/or server 112 may be embodied, in whole or in part, as device 502 comprising various components and connections to other components and/or systems. The components are variously embodied and may comprise processor 504. The term "processor," as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., "cloud", farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 110 may be embodied, in whole or in part, as network 520. Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, "cloud," etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), "cloud", multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., "cloud" based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as "the cloud," but may include a public, private, dedicated, shared and/or other service bureau, computing service, and/or "server farm."

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22nm Haswell, Intel® Core® i5-3570K 22nm Ivy Bridge, the AMD® FX™ family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, "cloud" or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable "source code" software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
presenting, by a server, a first virtual meeting space for use by a number of participants and conducting a first communication between the number of participants utilizing a corresponding number of participant devices;
allocating, by the server, a first number of collaboration resources to the first virtual meeting space;
receiving, by the server, from a first participant device of the number of participant devices, a first meeting identifier associated with the first virtual meeting space and, in response, admitting a first participant of the number of participants utilizing the first participant device to the first virtual meeting space;
creating, by the server, first meeting data utilizing at least one collaboration resource of the first number of collaboration resources;
persistently maintaining the first meeting data in a first tenanted virtual meeting space; and
upon the first participant device exiting the first virtual meeting space and subsequently being readmitted to the first virtual meeting space, resuming creation, by the server, of the first meeting data utilizing the at least one collaboration resource of the first number of collaboration resources.

2. The method of claim 1, further comprising:
presenting, by the server, a second virtual meeting space for use by the number of participants and conducting a second communication between the number of participants utilizing the corresponding number of participant devices;
allocating, by the server, a second number of collaboration resources to the second virtual meeting space;
receiving, by the server, from a second participant device of the number of participant devices, a second meeting identifier associated with the second virtual meeting space and, in response, admitting a second participant of the number of participants utilizing the second participant device to the second virtual meeting space;
creating, by the server, second meeting data utilizing the at least one collaboration resource of the second number of collaboration resources;
persistently maintaining the second meeting data in a second tenanted virtual meeting space; and
upon the second participant device exiting the second virtual meeting space and subsequently being readmitted to the second virtual meeting space, resuming creation, by the server, of the second meeting data utilizing the at least one collaboration resource of the second number of collaboration resources.

3. The method of claim 2, further comprising:
administering, by an administrative server, data retention policies to each of the first tenanted virtual meeting space and the second tenanted virtual meeting space.

4. The method of claim 2, further comprising:
administering, by an administrative server, security policies to each of the first tenanted virtual meeting space and the second tenanted virtual meeting space determining whether to admit any participant, comprising at least one of the first participant and the second participant, to a particular virtual meeting space, comprising at least one of the first virtual meeting space and the second virtual meeting space.

5. The method of claim 2, wherein the first number of collaboration resources and the second number of collaboration resources are an identical set of collaboration resources.

6. The method of claim 2, wherein the first number of collaboration resources and the second number of collaboration resources each comprise at least one resource including audio, video, messaging, text chat, email, screen sharing, whiteboarding, conferencing, file sharing, file transfer, presence information, floor control, and recording.

7. The method of claim 1, wherein the first meeting identifier is one of a direct inward dial (DID) or a user identifier.

8. The method of claim 1, further comprising:
receiving, by the server, from the first participant device, the first meeting identifier associated with the first virtual meeting space and, in response, declining to admit the first participant upon one of (a) a failure to match the first participant or the first participant device to an authorized list of participants or (b) the time the first meeting identifier was received by the server is outside a designated meeting time.

9. A system, comprising:
a network;
a computer, the computer comprising at least one processor coupled to a computer memory having stored thereon instructions that cause the at least one processor to perform:
presenting a first virtual meeting space for use by a number of participants and conducting a first communication between the number of participants utilizing a number of participant devices corresponding to the number of participants;
allocating a first number of collaboration resources to the first virtual meeting space;
receiving, from a first participant device of the number of participant devices, a first meeting identifier associated with the first virtual meeting space and, in response, admitting a first participant of the number of participants utilizing the first participant device to the first virtual meeting space;
creating first meeting data utilizing at least one collaboration resource of the first number of collaboration resources;
persistently maintaining the first meeting data in a first tenanted virtual meeting space; and
upon the first participant device exiting the first virtual meeting space and, at a later time, being readmitted to the first virtual meeting space, resuming creation of the first meeting data utilizing the at least one collaboration resource of the first number of collaboration resources.

10. The system of claim 9, wherein the instructions further cause the processor to perform:
presenting a second virtual meeting space for use by a number of participants and conducting a second communication between the number of participants utilizing a corresponding number of participant devices;
allocating a second number of collaboration resources to the second virtual meeting space;
receiving, from a second participant device of the number of participant devices, a second meeting identifier associated with the second virtual meeting space and, in response, admitting a second participant of the number of participants utilizing the second participant device to the second virtual meeting space;
creating second meeting data utilizing at least one collaboration resource of the second number of collaboration resources;
persistently maintaining the second meeting data in a second tenanted virtual meeting space; and
upon the second participant device exiting the second virtual meeting space and, at a later time, being readmitted to the second virtual meeting space, resuming creation of the second meeting data utilizing the at least one collaboration resource of the second number of collaboration resources.

11. The system of claim 10, wherein the instructions further cause the processor to perform:
administering, by an administrative server, data retention policies to each of the first tenanted virtual meeting space and the second tenanted virtual meeting space.

12. The system of claim 10, wherein the instructions further cause the processor to perform:
administering, by an administrative server, security policies to each of the first tenanted virtual meeting space and the second tenanted virtual meeting space determining whether to admit any participant, comprising at least one of the first participant and the second participant, to a particular virtual meeting space, comprising at least one of the first virtual meeting space and the second virtual meeting space.

13. The system of claim 10, wherein the first number of collaboration resources and the second number of collaboration resources are an identical set of collaboration resources.

14. The system of claim 10, wherein the first number of collaboration resources and the second number of collaboration resources each comprise at least one resource including audio, video, messaging, text chat, email, screen sharing, whiteboarding, conferencing, file sharing, file transfer, presence information, floor control, and recording.

15. The system of claim 9, wherein the first meeting identifier is one of a direct inward dial (DID) or a user identifier.

16. The system of claim 9, wherein the first meeting identifier is an email address.

17. The system of claim 9, wherein the instructions further cause the processor to perform:
receiving, from the first participant device, the first meeting identifier associated with the first virtual meeting space and, in response, declining to admit the first participant upon one of (a) a failure to match the first participant or the first participant device to an authorized list of participants or (b) the time the first meeting identifier was received is outside a designated meeting time.

18. A computer-readable medium coupled to a processor, the medium comprising one or more computer readable instructions, the processor executing the one of more computer readable instructions to:
present a first virtual meeting space for use by a number of participants and conduct communication between the number of participants utilizing a corresponding number of participant devices;
allocate a first number of collaboration resources to the first virtual meeting space;
receive, from a first participant device of the number of participant devices, a first meeting identifier associated with the first virtual meeting space and, in response, admit a first participant of the number of participants utilizing the first participant device to the first virtual meeting space;
create first meeting data utilizing at least one collaboration resource of the first number of collaboration resources;
persistently maintain the first meeting data in a first tenanted virtual meeting space; and
upon the first participant device exiting the first virtual meeting space and, at a later time, being readmitted to the first virtual meeting space, resume creation of the first meeting data utilizing the at least one collaboration resource of the first number of collaboration resources.

19. The computer-readable medium of claim 18, wherein the one or more computer readable instructions to cause the processor to execute:
presenting a second virtual meeting space for use by a number of participants and conducting communication between the number of participants utilizing a corresponding number of participant devices;
allocating a second number of collaboration resources to the second virtual meeting space;
receiving, from a second participant device of the number of participant devices, a second meeting identifier associated with the second virtual meeting space and, in response, admitting a second participant of the number of participants utilizing the second participant device to the second virtual meeting space;
creating second meeting data utilizing at least one collaboration resource of the second number of collaboration resources;
persistently maintaining the second meeting data in a second tenanted virtual meeting space; and
upon the second participant device exiting the second virtual meeting space and, at a later time, being readmitted to the second virtual meeting space, resuming creation of the second meeting data utilizing the at least one collaboration resource of the second number of collaboration resources.

20. The computer-readable medium of claim 19, wherein the one or more computer readable instructions cause the processor to execute:
administering, by an administrative server, data retention policies to each of the first tenanted virtual meeting space and the second tenanted virtual meeting space comprising security policies to each of the first tenanted virtual meeting space and the second tenanted virtual meeting space determining whether to admit any participant, comprising at least one of the first participant and the second participant, to a particular virtual meeting space, comprising at least one of the first virtual meeting space and the second virtual meeting space.
